(19) United States
(12) Patent Application Publication
(10) Pub. No.: US 2026/0166684 A1
(43) Pub. Date: Jun. 18, 2026

(54) Open-end Ratchet Wrench

(71) Applicants: CHIA-HSUAN LEE, Changhua City (TW); Kai Zhang, Zhangjiagang City, Jiangsu Province (CN)

(72) Inventors: CHIA-HSUAN LEE, Changhua City (TW); Kai Zhang, Zhangjiagang City, Jiangsu Province (CN)

(21) Appl. No.: 18/977,968

(22) Filed: Dec. 12, 2024

(51) Int. Cl. B25B 13/46

(52) U.S. Cl. CPC B25B 13/463

(57) ABSTRACT

The present invention is an open-end ratchet wrench, the jaw holder of which has a main hole with an opening for pivoting a ratchet wheel with external teeth. The ratchet wheel is provided with a wrench hole with a channel. The first and second chambers are recessed in the wall surface of the main hole for installing the first and second detents which are acted upon by springs and engaged with external teeth. The jaw holder has the first and second holes connecting the first and second chambers for pivotal connection of the first and second shaft members. The first and second shaft members each have a spring installed below and an eccentric above. The top surface of the jaw holder is equipped with a dial that can actuate the two eccentric portions, so that the dial can be shifted between first and second gear.

### BACKGROUND OF THE PRESENT INVENTION

### Field of Invention

The present invention is an open-end ratchet wrench suitable for disassembling and assembling pipe nuts, which can adjust the force direction as desired and is in line with the improvement of economical manufacturing efficiency.

### Description of Related Arts

The early technology is shown in U.S. Pat. No. 2,551,669, and its development so far still has the following shortcomings:
1. It can be adjusted to apply force in the forward or reverse direction through the upward and downward turning of the wrench body, in order to cope with the installation of the pipe, one end of the nut needs to be tightened in the forward direction, and the other end of the nut needs to be tightened in the reverse direction. Similarly, when removing the nuts at both ends of the pipe, the direction of force application will also change. As a result, the open-end ratchet wrench needs to perform actions such as disconnecting from the pipe, turning the wrench body over, and then inserting the pipe in order to cope with the need to change the direction of force application. These actions greatly increase the operating burden.
2. After the removal of the pipe nuts is completed, the ratchet wheel and the pipe are usually in the position where they cannot be separated. It is necessary to rotate the ratchet wheel idle return to control the ratchet channel to align and connect to the opening of the wrench body before it can be separated from the pipe. Therefore, the upper and lower parts of the ratchet wheel need to be provided with knobs for idle return operation. The current technology is in the ratchet wheel processing of an upper knob, and installed a removable lower knob, but the technology does not meet the cost-effective.

### SUMMARY OF THE PRESENT INVENTION

The present invention provides an open-end ratchet wrench which can improve the above-mentioned shortcomings. It comprises two aspects:
1. The present invention has a first hole matching the first detent and a second hole matching the second detent recessed from the top surface of the jaw holder. The first and second holes are pivotally connected with the first and second shaft members. Each of the first and second shaft members has an eccentric portion arranged at the top end thereof. A dial capable of actuating two eccentric portions is arranged on the top surface of the jaw holder. The dial can be switched between the first gear and the second gear, and the two detents are actuated to adjust the force direction of the ratchet wheel. This eliminates the need for complex operations such as detaching the pipe, turning over the wrench body, and inserting the pipe in the previous technology, making it easier for the user to change directions.
2. In the present invention, a detachable knob is installed on the top edge of the outer periphery of the ratchet wheel, and another detachable knob is installed on the bottom edge, so that the two knobs restrict the ratchet wheel from coming out of the wrench body and can link the ratchet wheel to rotate. Since the two knobs that can be detachably mounted to the ratchet wheel are manufactured in a unified manner, the overall cost is easy to control, and therefore it is more economical than the previous technology.

### BRIEF DESCRIPTION OF THE DRAWINGS

FIG. 1 is an exploded view according to the present invention.

FIG. 2 is an enlarged partial view of the knob in FIG. 1.

FIG. 3 is a partially assembled perspective view of FIG. 1.

FIG. 4 is an assembled perspective view of FIG. 1.

FIG. 5 is a top view of the present invention in the neutral position.

FIG. 6 is a sectional view of the A-A position as shown in FIG. 5.

FIG. 7 is a sectional view of the B-B position as shown in FIG. 6.

FIGS. 8 and 9 are position views of the main components of the present invention in the first gear.

FIGS. 10 and 11 are position views of the main components of the present invention in the second gear.

### DETAILED DESCRIPTION OF THE PREFERRED EMBODIMENT

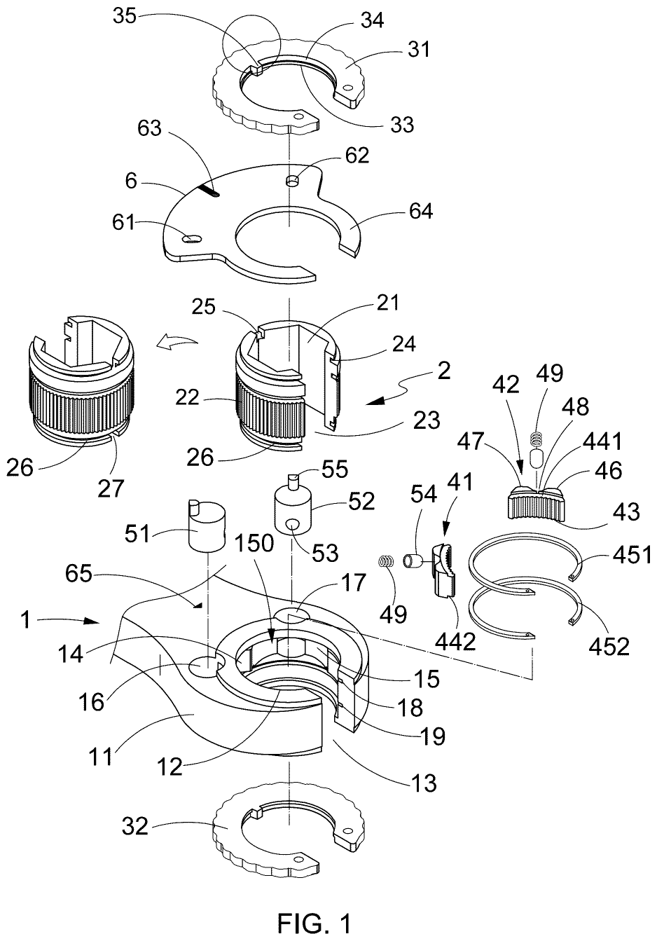

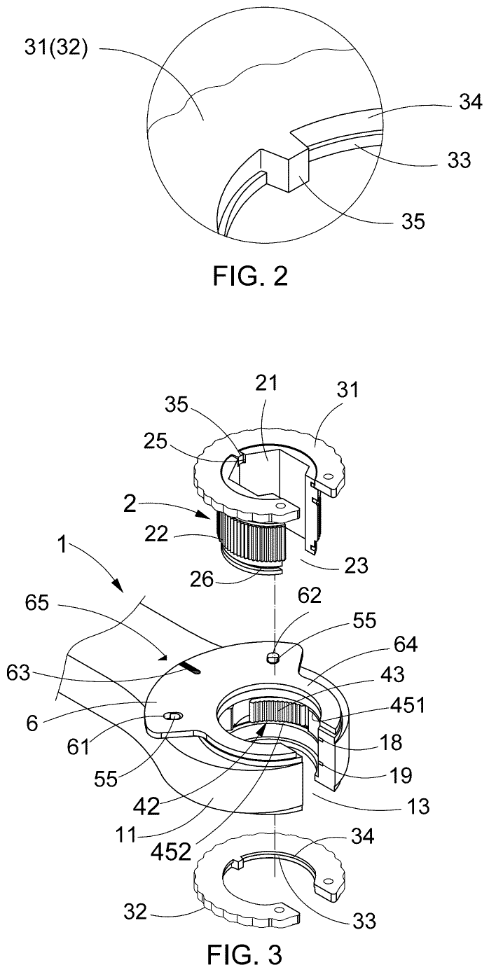

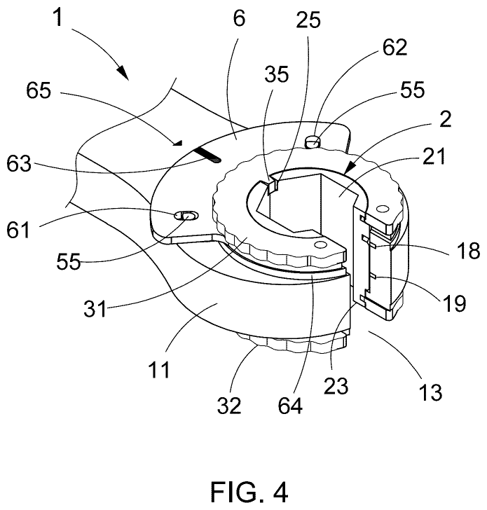

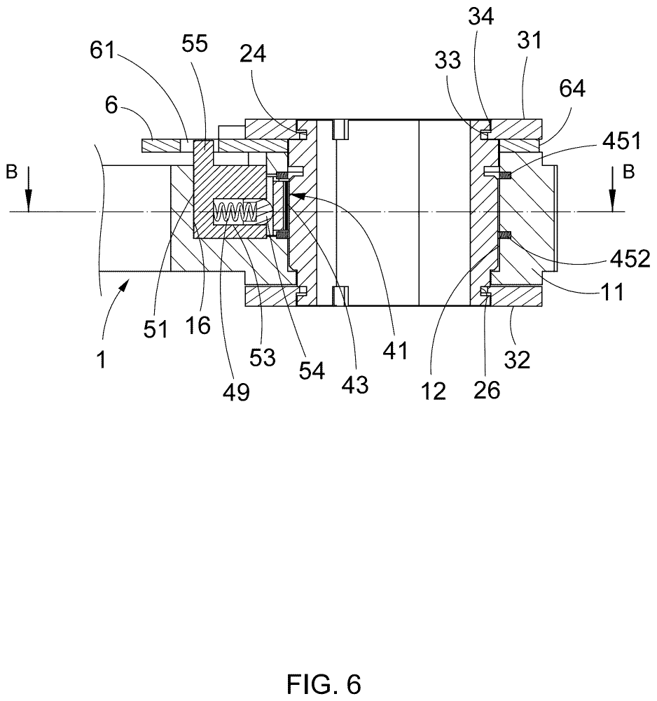

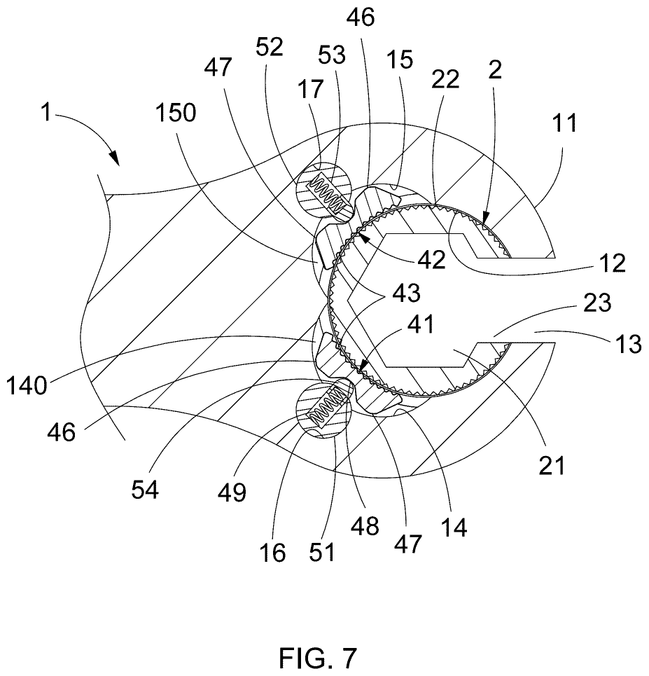

Referring to FIGS. 1 to 11. The present invention at least includes: a wrench body (1) having a jaw holder (11) extending forward, a main hole (12) running longitudinally through the jaw holder (11), and an opening (13) cut open and communicating with the main hole (12) at a front end thereof, wherein an inner circumference of the main hole (12) is slightly C-shaped, wherein a first arc surface (14) and a second arc surface (15) are recessed along the radial direction of the main hole (12) on the wall surface of the main hole (12) away from the opening (13), wherein a first chamber (140) is formed between the first arc surface (14) and the main hole (12), and a second chamber (150) is formed between the second arc surface (15) and the main hole (12), wherein a first hole (16) communicated to the first chamber (140) is recessed downwardly on the top surface of the jaw holder (11), and a second hole (17) communicated to the second chamber (150) is recessed downwardly on the top surface of the jaw holder (11), wherein two inner ring grooves (18) (19) are recessed in the wall surface of the main hole (12), one of the inner ring grooves (18) communicating with the upper edges of the first chamber (140) and the second chamber (150), and the other inner ring groove (19) communicating with the lower edges of the first chamber (140) and the second chamber (150);
a ratchet wheel (2) having a regular hexagonal wrench hole (21) longitudinally penetrating through a center thereof, the wrench hole (21) being capable of cooperating with the nut on the pipe to tighten or loosen the nut, wherein the outer periphery of the ratchet wheel (2) is pivoted in the main hole (12), and is capable of coaxial rotation, and has a plurality of external teeth (22), wherein a channel (23) is radially cut to communicate the inside and the outside of the wrench hole (21) so that the outer periphery of the ratchet wheel (2) is slightly C-shaped, wherein the channel (23) allows communication between the wrench hole (21) and the opening (13), so as to provide the pipe to pass in and out of the wrench hole (21) and enable the wrench hole (21) to carry out subsequent tightening or loosening nut operation, wherein a top buckle groove (24) is provided around the top edge of the outer periphery of the ratchet wheel (2), and an upper tenon groove (25) intersecting and communicating with the top buckle groove (24), and is provided at a position far away from and opposite to the channel (23), wherein the upper tenon groove (25) is milled downward from the top of the ratchet wheel (2), wherein a bottom buckle groove (26) is provided around the bottom edge of the outer periphery of the ratchet wheel (2), and a lower tenon groove (27) intersecting and communicating with the bottom buckle groove (26), and is provided at a position far away from and opposite to the channel (23), wherein the lower tenon groove (27) is milled upward from the bottom end of the ratchet wheel (2);
two C-shaped knobs (31) (32), referring to FIG. 2, each have a tab (33) on an inner periphery thereof that snaps into the top buckle groove (24) or the bottom buckle groove (26), and a stepped height difference surface (34) is connected on the outer periphery of the tab (33), so that the height difference surface (34) is allowed to butt against the outer periphery of the ratchet wheel (2), wherein the two knobs (31) (32) each have a tenon block (35) extending from the tab (33) and the height difference surface (34), wherein the tenon block (35) matches the upper tenon groove (25) or the lower tenon groove (27), wherein the tab (33) and tenon block (35) of the knob (31) are installed in the top buckle groove (24) and the upper tenon groove (25), and are limited to the top surface of the jaw holder (11), wherein the tab (33) and tenon block (35) of the other knob (32) are installed in the bottom buckle groove (26) and the lower tenon groove (27), and are limited to the bottom surface of the jaw holder (11), so that the two knobs (31) (32) are enough to restrict the ratchet wheel (2) from coming out of the main hole (12), wherein the tenon blocks (35) of the two knobs (31) (32) integrally link and move the upper tenon groove (25) and the lower tenon groove (27), so that the ratchet wheel (2) allows idle return, and a user can select to rotate any one of the knobs (31) (32) nearby, thereby controlling the channel (23) to be communicated with the opening (13) in an aligned manner, so that the pipe can smoothly come out of the wrench hole (21) after the nut is tightened or loosened by the wrench hole (21), wherein the two knobs (31) (32) abut against the outer periphery of the ratchet wheel (2) with a large area of the height difference surface (34), so that the rotation of the ratchet wheel (2) is relatively stable when the ratchet wheel (2) rotates in one piece;
two detents (41) (42), the first detent (41) is installed in the first chamber (140), and the second detent (42) is installed in the second chamber (150), wherein each of the two detents (41) (42) has a plurality of detent teeth (43) capable of engaging with the external teeth (22) and provided on the front side thereof, and two positioning grooves (441) (442) matching the inner ring grooves (18) and (19) and provided on the front side thereof and used to install two C-fasteners (451) (452), thereby preventing the first detent (41) from exiting the first chamber (140) and the second detent (42) from exiting the second chamber (150), wherein the inner hole diameter of each of the C-fasteners (451) (452) larger than the outer diameter of the ratchet wheel (2), so that the C-fastener (451) (452) will not interfere with the installation of the ratchet wheel (2) into the main hole (12), wherein the two detents (41) (42) each have a left abutment surface (46) at the left end of the converging connecting detent teeth (43) on the left end edge of the back side thereof, a right abutment surface (47) at the right end of the converging connecting detent teeth (43) on the right edge of the back side thereof, and a coupling area (48) is recessed between the left abutment surface (46) and the right abutment surface (47), wherein the coupling area (48) is provided with a spring (49), so that the spring (49) is allowed to provide pre-pressure to the corresponding detents (41) (42), so that the two detents (41) (42) have the potential to position C-fastener (451) (452) at any time, and have the potential to mesh the external teeth (22) at any time, and control the left abutment surface (46) and the right abutment surface (47) to keep not touching the matched first arc surface (14) or the second arc surface (15) at the same time, so that the detents (41) (42) each have a margin for forward or reverse displacement;
two shaft members (51) (52), the first shaft member (51) being pivotally connected to the first hole (16), and the second shaft member (52) being pivotally connected to the second hole (17), wherein the two shaft members (51) (52) each have a guide hole (53) radially recessed at a bottom side thereof, wherein the guide hole (53) is used to place the spring (49), and a bullet-shaped top detent (54) is slidably provided between the spring (49) and the coupling area (48), wherein the top detent (54) is allowed to move in and out linearly along the guide hole (53), so that the spring (49) pushes the top detent (54) and indirectly acts on the back of the corresponding detent (41) (42), so as to improve the flexibility problem of the spring (49) direct acting on the coupling area (48), wherein the two shaft members (51) (52) further each have an eccentric portion (55) protruding from the top surface of the jaw holder (11) and located at the top end thereof;
a dial (6) slidably installed between the knob (31) above and the top surface of the jaw holder (11) to allow switching between the first gear and the second gear, and has a first rail (61) that allows the eccentric portion (55) of the first shaft member (51) to be actuated to deviate, and a second rail (62) that allows the eccentric portion (55) of the second shaft member (52) to be actuated to deviate, a mark (63) located between the first rail (61) and the second rail (62), and a C-shaped support portion (64) that corresponds to and is adjacent to the outer periphery of the C-shaped ratchet wheel (2).

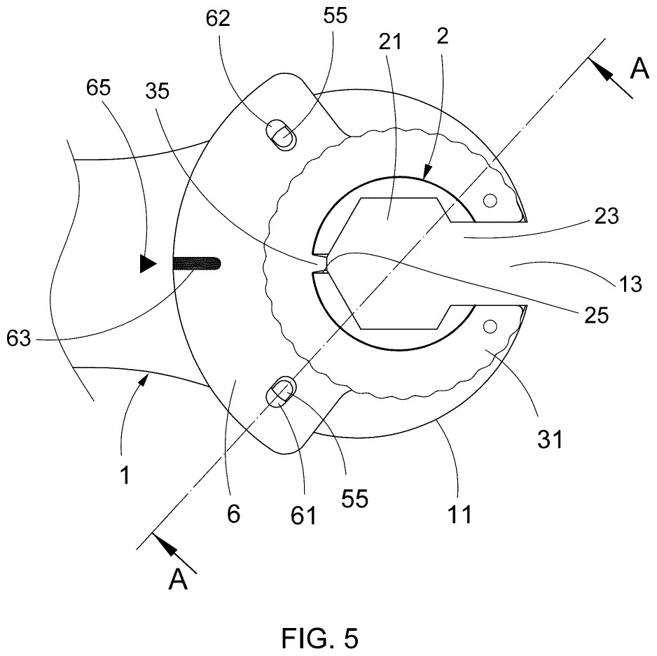

FIGS. 5 to 7 show the positions of the main relevant components when the dial (6) is in a neutral position. The neutral position is relatively in the center between the first gear and the second gear. At this time, the first rail (61) and the second rail (62) link the two detents (41) (42) through the two shaft members (51) (52), so that the two detents (41) (42) maintain in the center of the first chamber (140) and the second chamber (150), and the left abutment surface (46) and the right abutment surface (47) of the two detents (41) (42) are kept out of contact with the corresponding first arc surface (14) and second arc surface (15), so that the wrench body (1) cannot drive the wrench hole (21) to exert force in a forward direction or a reverse direction to loosen or tighten the nut, and the two knobs (31) (32) can be linked with the ratchet wheel (2) to rotate in a forward direction or a reverse direction so as to control the channel (23) to communicate with the opening (13). When the dial (6) is in the neutral position, the mark (63) is located at the center of the wrench body (1). In order to increase the visual recognition of the neutral state, a symbol (65) aligned with the mark (63) is provided on the wrench body (1).

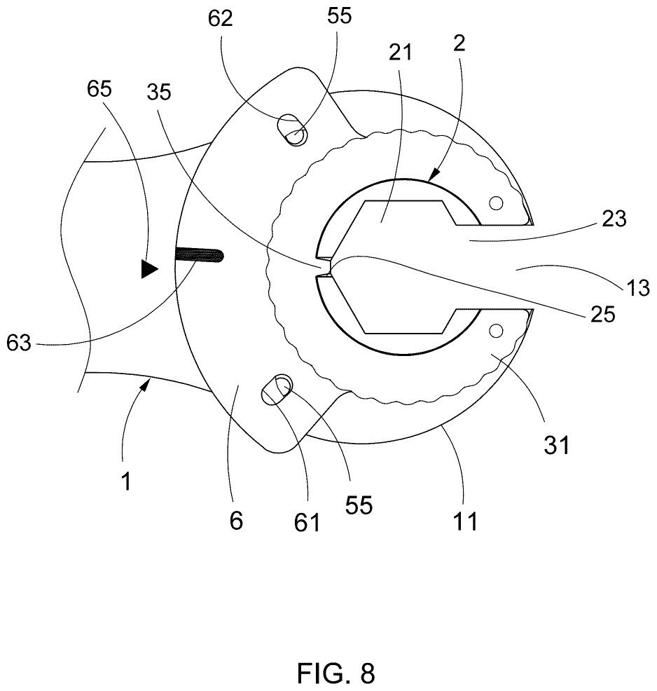

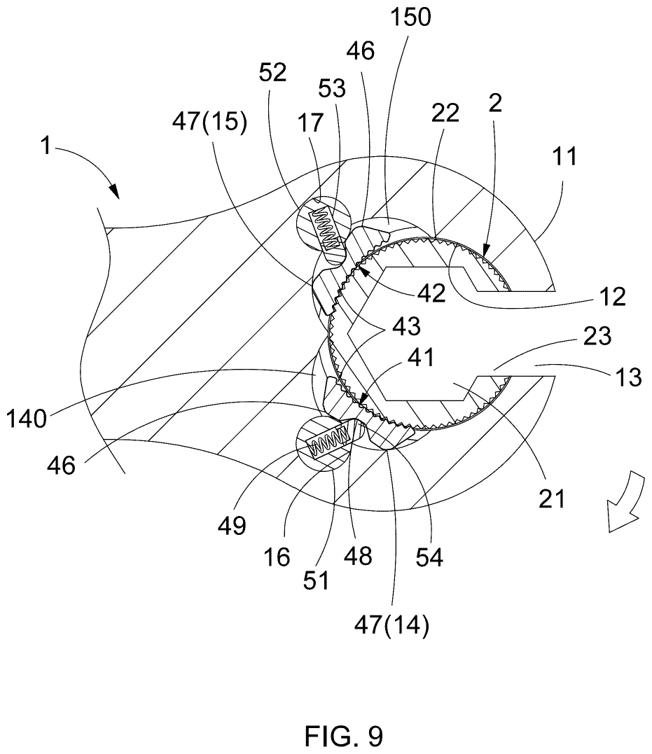

As shown in FIGS. 8 to 9, when a user pushes the dial (6) to swing clockwise to a position where the dial cannot move further, the mark (63) remains at the clockwise position of the mark (65) to indicate that the dial (6) is switches to the first gear. At this time, the first rail (61) and the second rail (62) will drive the two eccentric portions (55) together, and then link the two shaft members (51) (52) to rotate at an angle in the clockwise direction, so that the two top detents (54) push the positions of the coupling areas (48) of the two detents (41) (42) to change together to control the counter-clockwise displacement of the two detents (41) (42) in the corresponding first chamber (140) and second chamber (150), and then the right abutment surface (47) is stuck in the counter-clockwise position of the corresponding first arc surface (14) or the second arc surface (15), so that the wrench body (1) can drive the wrench hole (21) in the clockwise direction to tighten the nut. When the present invention wants to break away from the pipe with the tightened nut, it can directly return by idling counterclockwise through the wrench body (1). When the channel (23) is communicated to the opening (13), operate the wrench hole (21) to disengage from the nut, and then allow the pipe to disengage from the wrench hole (21) along the channel (23) and the opening (13).

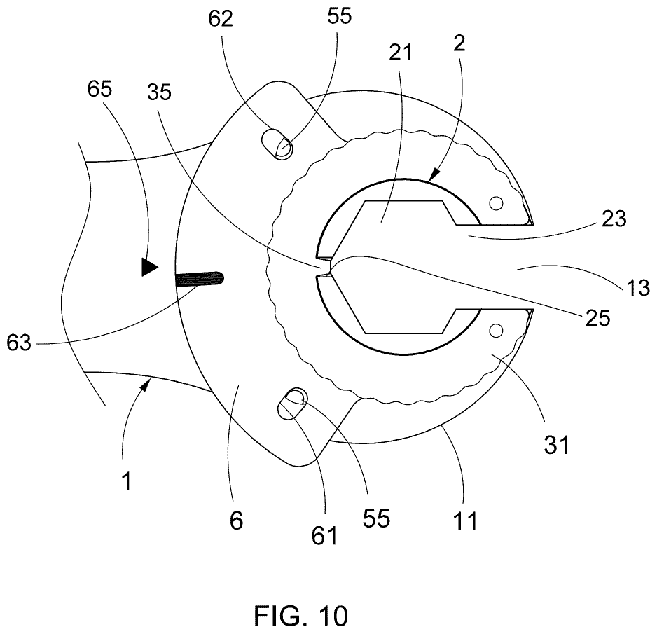

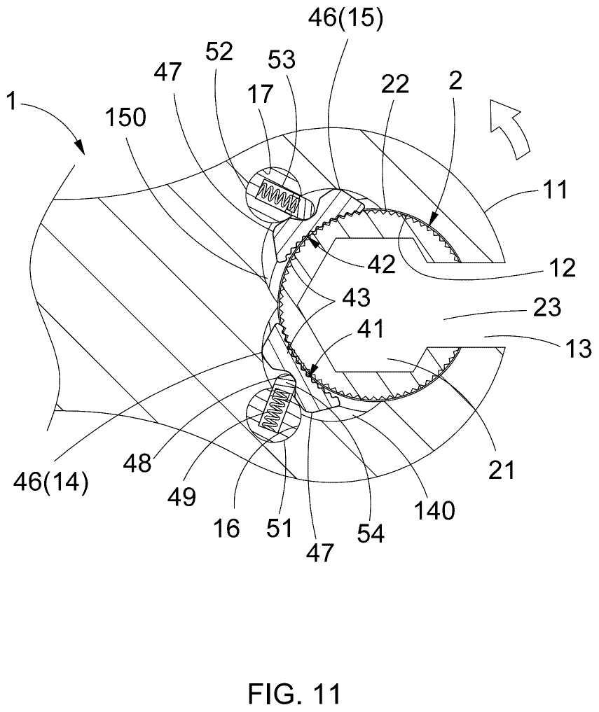

As shown in FIGS. 10 to 11, when the user pushes the dial (6) to swing counter-clockwise to a position where the dial cannot move further, the mark (63) remains at the counter-clockwise position of the mark (65) to indicate that the dial (6) switches to the second gear. The first rail (61) and the second rail (62) link the two shaft members (51) (52) to rotate in counter-clockwise direction to a fixed point, and synchronously convert the two top detents (54) to push the positions of the coupling areas (48) of the two detents (41) (42) to control the clockwise displacement of the two detents (41) (42) in the matching first chamber (140) and second chamber (150), and conversion into the left abutment surface (46) jammed in the clockwise position that the corresponding first arc surface (14) or the second arc surface (15), so that the wrench body (1) drive the wrench hole (21) of the ratchet wheel (2) in the counter-clockwise direction to loosen the nut. When the present invention wants to disengage the pipe of the loosening nut, it is necessary to operate the wrench hole (21) to disengage the nut, and then use any knob (31) (32) to drive the ratchet wheel (2) to return by idling in the counterclockwise direction. When the channel (23) is communicated with the opening (13), the pipe can be separated from the wrench hole (21).

The above is only one of the preferred embodiments of the present invention and should not be used to limit the implementation scope of the present invention; that is, all equivalent changes and modifications made according to the patent scope of the present invention belong to the present invention.

What is claimed is:

1. An open-end ratchet wrench, comprising:
a wrench body (1) having a jaw holder (11) extending therefrom, a main hole (12) running longitudinally through the jaw holder (11), and an opening (13) cut open and communicated with the main hole (12), a first arc surface (14) and a second arc surface (15) recessed on the wall surface of the main hole (12) to form a first chamber (140) and a second chamber (150) correspondingly, and a first hole (16) communicating with the first chamber (140) and a second hole (17) communicating with the second chamber (150) recessed on the top surface of the jaw holder (11);
a ratchet wheel (2) having a wrench hole (21) penetrating through a center thereof, a plurality of external teeth (22) arranged on an outer periphery thereof and pivoted on the main hole (12), and a channel (23) provided to communicate between the wrench hole (21) and the opening (13);
two knobs (31) (32), wherein one knob (31) is matched with the top edge of the ratchet wheel (2) and is limited to the top surface of the jaw holder (11), the other knob (32) is matched with the bottom edge of the ratchet wheel (2) and is limited to the bottom surface of the jaw holder (11), wherein the two knobs (31) (32) restrict the ratchet wheel (2) from coming out of the main hole (12), and allow the ratchet wheel (2) to rotate in linkage;
two detents (41) (42), wherein the first detent (41) is installed in the first chamber (140), and the second detent (42) is installed in the second chamber (150), wherein each of the two detents (41) (42) has a plurality of detent teeth (43) arranged on a front side thereof and capable of engaging with the external teeth (22), and a coupling area (48) on a back side thereof for the action of a spring (49), thereby enabling the detent teeth (43) to engage the external teeth (22) at any time;
two shaft members (51) (52), wherein the first shaft member (51) is pivotally connected with the first hole (16), and the second shaft member (52) is pivotally connected with the second hole (17), wherein each of the two shaft members (51)(52) is fitted at the bottom with the spring (49) and a top detent (54) so that the spring (49) pushes the top detent (54) to act on the corresponding coupling area (48), wherein each of the two shaft members (51)(52) has an eccentric portion (55) at the top end thereof; and
a dial (6) installed on the top surface of the jaw holder (11) to allow switching between a first gear and a second gear, and has a first rail (61) that allows actuating the eccentric portion (55) of the first shaft member (51), and a second rail (62) that allows actuating the eccentric portion (55) of the second shaft member (52), wherein when the dial

(6) is in the first gear, the first rail (61) and the second rail (62) synchronously drive the two shaft members (51) (52) to rotate at an angle to control the two detents (41) (42) is stuck in the counter-clockwise position of the corresponding first arc surface (14) and second arc surface (15), so that the wrench body (1) drives the wrench hole (21) to apply force in the clockwise position, wherein when the dial (6) is switched to the second gear, the two detents (41) (42) are linked to change direction and be locked to the clockwise position of the corresponding first arc surface (14) and second arc surface (15), so that the wrench body (1) drives the wrench hole (21) to apply force in the counter-clockwise direction.

2. The open-end ratchet wrench, as recited in claim 1, wherein the dial (6) is further capable of switching between the first gear, a neutral gear, and the second gear, when the dial (6) is in the neutral gear, the two detents (41) (42) remain out of contact with the corresponding first arc surface (14) and second arc surface (15).

3. The open-end ratchet wrench, as recited in claim 1, wherein the dial (6) has a mark (63) provided thereon, wherein the wrench body (1) has a symbol (65) matching the mark (63) and arranged thereon.

4. The open-end ratchet wrench, as recited in claim 1, wherein the dial (6) is slidably installed between the knob (31) above and the top surface of the jaw holder (11), and has a support portion (64) adjacent to the outer periphery of the ratchet wheel (2).

5. The open-end ratchet wrench, as recited in claim 2, wherein the dial (6) is slidably installed between the knob (31) above and the top surface of the jaw holder (11), and has a support portion (64) adjacent to the outer periphery of the ratchet wheel (2).

6. The open-end ratchet wrench, as recited in claim 3, wherein the dial (6) is slidably installed between the knob (31) above and the top surface of the jaw holder (11), and has a support portion (64) adjacent to the outer periphery of the ratchet wheel (2).

7. The open-end ratchet wrench, as recited in claim 1, wherein each of the two shaft members (51) (52) has a guide hole (53) radially recessed at a bottom side thereof, wherein the guide hole (53) is inserted with the spring (49), and the top detent (54) is slidably provided between the spring (49) and the coupling area (48).

8. The open-end ratchet wrench, as recited in claim 2, wherein each of the two shaft members (51) (52) has a guide hole (53) radially recessed at a bottom side thereof, wherein the guide hole (53) is inserted with the spring (49), and the top detent (54) is slidably provided between the spring (49) and the coupling area (48).

9. The open-end ratchet wrench, as recited in claim 3, wherein each of the two shaft members (51) (52) has a guide hole (53) radially recessed at a bottom side thereof, wherein the guide hole (53) is inserted with the spring (49), and the top detent (54) is slidably provided between the spring (49) and the coupling area (48).

10. The open-end ratchet wrench, as recited in claim 1, wherein the two detents (41) (42) each have a left abutment surface (46) at the left end of back side thereof that converges and connects the detent teeth (43) at the left end of the front side, a right abutment surface (47) at the right end of back side thereof that converges and connects the detent teeth (43) at the right end of the front side, and the coupling area (48) recessed between the left abutment surface (46) and the right abutment surface (47), wherein when the dial (6) is switched to the first gear, the right abutment surfaces (47) of the two detents (41) (42) will be stuck in the counter-clockwise position of the corresponding first arc surface (14), the second arc surface (15), and when the dial (6) is switched to the second gear, the left abutment surfaces (46) of the two detents (41) (42) will be stuck in the clockwise position of the corresponding first arc surface (14) and the second arc surface (15) .

11. The open-end ratchet wrench, as recited in claim 2, wherein the two detents (41) (42) each have a left abutment surface (46) at the left end of back side thereof that converges and connects the detent teeth (43) at the left end of the front side, a right abutment surface (47) at the right end of back side thereof that converges and connects the detent teeth (43) at the right end of the front side, and the coupling area (48) recessed between the left abutment surface (46) and the right abutment surface (47), wherein when the dial (6) is switched to the first gear, the right abutment surfaces (47) of the two detents (41) (42) will be stuck in the counter-clockwise position of the corresponding first arc surface (14), the second arc surface (15), and when the dial (6) is switched to the second gear, the left abutment surfaces (46) of the two detents (41) (42) will be stuck in the clockwise position of the corresponding first arc surface (14) and the second arc surface (15).

12. The open-end ratchet wrench, as recited in claim 3, wherein the two detents (41) (42) each have a left abutment surface (46) at the left end of back side thereof that converges and connects the detent teeth (43) at the left end of the front side, a right abutment surface (47) at the right end of back side thereof that converges and connects the detent teeth (43) at the right end of the front side, and the coupling area (48) recessed between the left abutment surface (46) and the right abutment surface (47), wherein when the dial (6) is switched to the first gear, the right abutment surfaces (47) of the two detents (41) (42) will be stuck in the counter-clockwise position of the corresponding first arc surface (14), the second arc surface (15), and when the dial (6) is switched to the second gear, the left abutment surfaces (46) of the two detents (41) (42) will be stuck in the clockwise position of the corresponding first arc surface (14) and the second arc surface (15).

13. The open-end ratchet wrench, as recited in claim 1, wherein the ratchet wheel (2) has a top buckle groove (24) around provided on the top edge of the outer periphery thereof and an upper tenon groove (25) intersecting with the top buckle groove (24), wherein the ratchet wheel (2) has a bottom buckle groove (26) around provided on the bottom edge of the outer periphery thereof and a lower tenon groove (27) intersecting with the bottom buckle groove (26), wherein the one knob (31) is installed in the top buckle groove (24) and the upper tenon groove (25), and the other knob (32) is installed in the bottom buckle groove (26) and the lower tenon groove (27).

14. The open-end ratchet wrench, as recited in claim 2, wherein the ratchet wheel (2) has a top buckle groove (24) around provided on the top edge of the outer periphery thereof and an upper tenon groove (25) intersecting with the top buckle groove (24), wherein the ratchet wheel (2) has a bottom buckle groove (26) around provided on the bottom edge of the outer periphery thereof and a lower tenon groove (27) intersecting with the bottom buckle groove (26), wherein the one knob (31) is installed in the top buckle groove (24) and the upper tenon groove (25), and the other knob (32) is installed in the bottom buckle groove (26) and the lower tenon groove (27).

15. The open-end ratchet wrench, as recited in claim 3, wherein the ratchet wheel (2) has a top buckle groove (24) around provided on the top edge of the outer periphery thereof and an upper tenon groove (25) intersecting with the top buckle groove (24), wherein the ratchet wheel (2) has a bottom buckle groove (26) around provided on the bottom edge of the outer periphery thereof and a lower tenon groove (27) intersecting with the bottom buckle groove (26), wherein the one knob (31) is installed in the top buckle groove (24) and the upper tenon groove (25), and the other knob (32) is installed in the bottom buckle groove (26) and the lower tenon groove (27).

16. The open-end ratchet wrench, as recited in claim 1, wherein at least one inner ring groove (18) is provided on the wall surface of the main hole (12), and the inner ring groove (18) is communicated with the first chamber (140) and the second chamber (150), wherein the two detents (41) (42) each have a positioning groove (441) at positions corresponding to the inner ring groove (18) on the front side to provide corresponding installation of a C-fastener (451), wherein the inner diameter of the C-fastener (451) is larger than the outer diameter of the ratchet wheel (2).

17. The open-end ratchet wrench, as recited in claim 2, wherein at least one inner ring groove (18) is provided on the wall surface of the main hole (12), and the inner ring groove (18) is communicated with the first chamber (140) and the second chamber (150), wherein the two detents (41) (42) each have a positioning groove (441) at positions corresponding to the inner ring groove (18) on the front side to provide corresponding installation of a C-fastener (451), wherein the inner diameter of the C-fastener (451) is larger than the outer diameter of the ratchet wheel (2).

18. The open-end ratchet wrench, as recited in claim 3, wherein at least one inner ring groove (18) is provided on the wall surface of the main hole (12), and the inner ring groove (18) is communicated with the first chamber (140) and the second chamber (150), wherein the two detents (41) (42) each have a positioning groove (441) at positions corresponding to the inner ring groove (18) on the front side to provide corresponding installation of a C-fastener (451), wherein the inner diameter of the C-fastener (451) is larger than the outer diameter of the ratchet wheel (2).

19. An open-end ratchet wrench, comprising:
a wrench body (1) having a jaw holder (11) extending therefrom, a main hole (12) running longitudinally through the jaw holder (11), and an opening (13) cut open and communicated with the main hole (12), and a first arc surface (14) and a second arc surface (15) recessed on the wall surface of the main hole (12) to form a first chamber (140) and a second chamber (150) correspondingly;
a ratchet wheel (2) having a wrench hole (21) penetrating through a center thereof, a plurality of external teeth (22) arranged on an outer periphery thereof and pivoted on the main hole (12), and a channel (23) provided to communicate between the wrench hole (21) and the opening (13), wherein the ratchet wheel (2) has a top buckle groove (24) around provided on the top edge of the outer periphery thereof and an upper tenon groove (25) intersecting with the top buckle groove (24), wherein the ratchet wheel (2) has a bottom buckle groove (26) around provided on the bottom edge of the outer periphery thereof and a lower tenon groove (27) intersecting with the bottom buckle groove (26);
two knobs (31) (32), wherein one knob (31) is matched with the top buckle groove (24) and the upper tenon groove (25), and is limited to the top surface of the jaw holder (11), the other knob (32) is matched with the bottom buckle groove (26) and the lower tenon groove (27), and is limited to the bottom surface of the jaw holder (11), wherein the two knobs (31) (32) restrict the ratchet wheel (2) from coming out of the main hole (12), and link the rotation of the ratchet wheel (2) through the cooperation of the upper tenon groove (25) and the lower tenon groove (27); and
two detents (41) (42), wherein the first detent (41) is installed in the first chamber (140), and the second detent (42) is installed in the second chamber (150), wherein each of the two detents (41) (42) has a plurality of detent teeth (43) arranged on a front side thereof and capable of engaging with the external teeth (22), and a coupling area (48) on a back side thereof for the action of a spring (49), thereby enabling the detent teeth (43) to engage the external teeth (22) at any time.

20. The open-end ratchet wrench, as recited in claim 19, wherein two knobs (31) (32) each have a tab (33) on the inner periphery thereof that snaps into the top buckle groove (24) or the bottom buckle groove (26), and a stepped height difference surface (34) is formed to connect with the outer periphery of the tab (33), wherein the height difference surface (34) is butt against the outer periphery of the ratchet wheel (2), wherein the two knobs (31) (32) each have a tenon block (35) extending from the tab (33) and the height difference surface (34), wherein the tenon block (35) is matched with any the upper tenon groove (25) or the lower tenon groove (27).
